(19) United States
(12) Patent Application Publication
(10) Pub. No.: US 2025/0384274 A1
(43) Pub. Date: Dec. 18, 2025

(54) MULTI-ENCODER ARCHITECTURE

(71) Applicant: MASTERCARD TECHNOLOGIES CANADA ULC, Vancouver (CA)

(72) Inventors: Faraz Khoshbakhtian, Toronto (CA); Gaurav Oberoi, Meerut (IN); Siddhartha Asthana, New Delhi (IN)

(21) Appl. No.: 19/039,953

(22) Filed: Jan. 29, 2025

(30) Foreign Application Priority Data
Jun. 13, 2024 (IN) 202441045606

(51) Int. Cl. G06N 3/082; G06N 3/042; G06N 3/0455

(52) U.S. Cl. CPC G06N 3/082; G06N 3/042; G06N 3/0455

(57) ABSTRACT

A computer-implemented method, includes generating a plurality of task-specific embeddings at a plurality of task-specific encoders based on a plurality of input data structures, aggregating the plurality of task-specific embeddings to generate an aggregated embedding, applying a dimensionality-reduction technique to the aggregated embedding to the aggregated embedding to generate a final embedding, and providing the final embedding to a user device for use in a machine learning application.

### FIELD

The present disclosure relates to processing architectures for electrical computers and digital processing systems and, more particularly, to multi-encoder architectures for artificial intelligence and machine learning systems.

### SUMMARY

Data structures such as graph representations may provide a powerful and flexible way to model relationships and/or interactions between entities across a variety of domains, such as biological networks, transportation systems, and/or social networks. For example, biological networks and systems (such as protein-protein interactions, gene regulatory networks, biological neural networks, etc.) can be effectively modeled using graph representations. Nodes can represent biological entities (such as proteins, genes, neurons, etc.) while edges can represent interactions and/or connections between the entities.

Transportation systems may also be effectively modeled using graph representations. For example, nodes can represent locations (such as cities, intersections, etc.) while edges can represent routes (such as roads, railways, etc.). In the transportation system domain, graph representations may be used to optimize routes, manage traffic flow, plan infrastructure development, etc.

Social networks can also be effectively modeled using graph representations. For example, individuals can be represented as nodes, and the relationships and/or interactions between individuals can be represented as edges. In the social media domain, graph representations can be used to gain insight into social dynamics such as community structures, information dissemination, influence, etc.

In machine learning applications, embedding data structures such as graph representations before providing them to downstream machine learning models provide a variety of technical benefits that enhance the ability of the machine learning models to effectively learn from and/or analyze the graph representations. Generally, graph embeddings may represent the information present in a graph representation in a form that is particularly suitable for machine learning. For example, a graph embedding may capture the structural information, relationships, properties, and/or other relevant features of the graph representation in a form that is suitable for analysis and processing by downstream machine learning networks.

For example, graph embeddings may transform higher-dimensional graph representations into lower-dimensional vectors, matrices, and/or tensors. The lower-dimensional representations may be more manageable for machine learning models (such as, for example, neural networks), reducing computational requirements and improving the efficiency of training and/or inference processes. In order for graph embeddings to be more effective for downstream machine learning tasks, the graph embeddings may capture relevant inherent structural properties of the graph representations (such as node proximity, connectivity patterns, community structures, etc.), underlying patterns present in the graph representations, relationships present in the graph representations, etc.

Machine learning models (for example, encoders such as graph neural networks [GNNs]) may be particularly well-suited for generating useful graph embeddings due to their ability to capture the intricate and multi-faced relationships within data structures such as graph representations. Encoders may be trained using labeled graph representations when high-quality labels are available (which provide direct supervision to learn task-specific representations). However, in real-world scenarios, such labels may be scarce and/or costly to compute due to the complexity and effort required to accurately annotate graph representations. Thus, self-supervised learning (SSL) techniques, such as the use of self-supervised pretext tasks to train encoders on unlabeled graph representations, may be used as an alternative. Pretext tasks may be auxiliary tasks designed to provide supervision signals for training encoders without requiring labeled training data.

In SSL techniques for training encoders to generate graph embeddings, pretext tasks may exploit the inherent structure and properties of graph data to create meaningful learning objectives. For example, pretext tasks such as generative reconstruction, mutual information maximization, and/or whitening decorrelation may allow encoders to learn useful representations from unlabeled data structures (such as graph representations). By solving pretext tasks, encoders can learn to encode the complex relationships and/or structural information present in the graph representations into lower-dimensional graph embeddings. Encoders can be trained using a single pretext task or multiple pretext tasks.

Multi-task self-supervised learning (MT-SSL) approaches may be superior to single-task approaches in some contexts because using multiple pretext tasks encourages encoders to capture a wider range of features and/or dependencies within graph representations, which may enhance the richness and/or robustness of the learned embeddings generated by the encoders, and may lead to better generalization and/or performance across a range of downstream machine learning tasks that use the embeddings. However, conventional MT-SSL approaches that train a single encoder to minimize losses for multiple pretext tasks may suffer from technical problems such as task interference.

Task interference in MT-SSL approaches may occur when multiple pretext tasks compete for the encoder's capacity and expressivity, leading to conflicts in the optimization process and resulting in degraded performance across some or all of the pretext tasks. This may occur because the gradients of the different task loss functions (for example, each used to optimize the encoder for different pretext task during training) may point in conflicting directions, causing the encoder to struggle in minimizing all losses simultaneously. Additionally, the finite capacity of the encoder's parameters to represent knowledge can dilute its ability to specialize in any single task.

Thus, task interference can result in a variety of adverse technical impacts to the encoder's performance, such as degraded performance, slower convergence during training, and/or a reduced ability for the encoder to generalize across different types of tasks. For example, task interference can result in degraded performance on the encoder's ability to train to certain pretext tasks. This can result from the encoder being unable to dedicate sufficient representational power (for example, parameters) to any single pretext task. Task interference can also lead to slower convergence during training as the encoder oscillates between competing optimization directions, resulting in inefficient learning and/or prolonged training times.

Furthermore, task interference can impact the encoder's ability to generalize across different pretext tasks, as the encoder may be unable to adequately capture the nuances of each pretext task, which may lead to poor performance when the encoders are used to generate graph embeddings from previously unseen graph representations.

Systems, apparatuses, methods, and techniques described in this specification provide technical solutions to these problems by training a separate encoder for each pretext task (unlike conventional solutions that train a single encoder for multiple pretext tasks), generating a task-specific embedding with each encoder, and combining the task-specific embeddings into a final embedding, which may be used for downstream machine learning applications. Each encoder may be dedicated to a specific pretext task such as, for example, generative reconstruction, mutual information maximization, and/or whitening decorrelation.

Each task-specific encoder learns to generate a specialized task-specific embedding that captures unique aspects of the graph representations as related to their respective tasks. This may be achieved by training each task-specific encoder independently, for example, by using a separate encoder-decoder pair for each pretext task. For example, the task-specific encoder may process the input graph representation to generate the task-specific embedding, and the tasks-specific decoder may predict task specific targets using the task-specific embedding as an input. A task-specific loss may be calculated from the decoder's output and backpropagated through the encoder and/or decoder, adjusting the weights of the encoder and/or decoder to optimize performance for the specific pretext task.

Systems, apparatuses, methods, and techniques described herein effectively solve technical problems resulting from task interference by isolating the learning process for each pretext task. By providing a distinct encoder (and thus a distinct parameter space) for each task, the novel techniques described herein effectively eliminate competition for encoder capacity and/or conflicting gradient updates. During inference, the task-specific embeddings generated by respective task-specific encoders may be aggregated and a dimensionality reduction technique may be applied to the aggregated embeddings to create compact, generalized final embeddings for use in downstream machine learning applications. This final embedding incorporates the diverse features captured by each task-specific model, leading to a more robust and comprehensive representation.

Thus, systems, apparatuses, methods, and techniques described herein not only mitigate the technical problems caused by task interference but also provide additional technical benefits by leveraging the strengths of each pretext task, resulting in richer and more versatile final embeddings for downstream machine learning tasks. Furthermore, the modular solutions offered by the systems, apparatuses, methods, and techniques described herein make them suitable for deployment across a wide range of real-world applications.

A computer-implemented method, includes generating a plurality of task-specific embeddings at a plurality of task-specific encoders based on a plurality of input data structures, aggregating the plurality of task-specific embeddings to generate an aggregated embedding, applying a dimensionality-reduction technique to the aggregated embedding to the aggregated embedding to generate a final embedding, and providing the final embedding to a user device for use in a machine learning application.

In other features, the method includes generating each input data structure of the plurality of input data structures by augmenting a graph representation according to a respective pretext task. In other features, the method includes training each task-specific encoder of the plurality of task-specific encoders according to a respective pretext task. In other features, training each task-specific encoder of the plurality of task-specific encoders comprises providing each input data structure to a respective task-specific encoder to generate a respective task-specific embedding, providing each task-specific embedding to a respective task-specific decoder to generate a respective task-specific output, computing a task-specific loss for each task-specific output, and updating each task-specific encoder according to a respective task-specific loss.

In other features, the method includes computing each task-specific loss according to a respective task-specific loss function, computing a task-specific gradient according to each task-specific loss function, and backpropagating each task-specific gradient through a respective task-specific encoder. In other features, the method includes backpropagating each task-specific gradient through a respective task-specific decoder. In other features, each task-specific encoder comprises a graph neural network. In other features, applying the dimensionality-reduction technique comprises applying principal component analysis to reduce a dimensionality of the aggregated embedding. In other features, applying the dimensionality-reduction technique comprises applying an autoencoder to reduce a dimensionality of the aggregated embedding. In other features, applying the dimensionality-reduction technique comprises applying a variational autoencoder to reduce a dimensionality of the aggregated embedding.

A non-transitory computer-readable storage medium includes executable instructions. The executable instructions cause an electronic processor to generate a plurality of task-specific embeddings at a plurality of task-specific encoders based on a plurality of input data structures, aggregate the plurality of task-specific embeddings to generate an aggregated embedding, apply a dimensionality-reduction technique to the aggregated embedding to generate a final embedding, and provide the final embedding to a user device for use in a machine learning application.

In other features, the executable instructions cause the electronic processor to generate each input data structure of the plurality of input data structures by augmenting a graph representation according to a respective pretext task. In other features, the executable instructions cause the electronic processor to train each task-specific encoder according to a respective pretext task. In other features, the executable instructions cause the electronic processor to train each task-specific encoder according to the respective pretext task by providing each input data structure to a respective task-specific encoder to generate a respective task-specific embedding, providing each task-specific embedding to a respective task-specific decoder to generate a respective task-specific output, computing a task-specific loss for each task-specific output, and updating each task-specific encoder according to a respective task-specific loss.

In other features, the executable instructions cause the electronic processor to train each task-specific encoder according to the respective pretext task by computing each task-specific loss according to a respective task-specific loss function, computing a task-specific gradient according to each task-specific loss function, and backpropagating each task-specific gradient through a respective task-specific encoder. In other features, the executable instructions cause the electronic processor to train each task-specific encoder according to the respective pretext task by backpropagating each task-specific gradient through a respective task-specific decoder. In other features, each task-specific encoder comprises a graph neural network.

In other features, the executable instructions cause the electronic processor to apply the dimensionality-reduction technique to the aggregated embedding to generate the final embedding by applying principal component analysis to reduce a dimensionality of the aggregated embedding. In other features, the executable instructions cause the electronic processor to apply the dimensionality-reduction technique to the aggregated embedding to generate the final embedding by applying an autoencoder to reduce a dimensionality of the aggregated embedding. In other features, the executable instructions cause the electronic processor to apply the dimensionality-reduction technique to the aggregated embedding to generate the final embedding by applying a variational autoencoder to reduce a dimensionality of the aggregated embedding.

Other examples, embodiments, features, and aspects will become apparent by consideration of the detailed description and accompanying drawings.

### BRIEF DESCRIPTION OF THE DRAWINGS

FIG. 1 is a block diagram illustrating an example computing system for generating embeddings based on input data structures, according to some embodiments.

FIG. 2 is a schematic illustration of a process for training task-specific encoders and task-specific decoders to minimize task-specific losses for a plurality of pretext tasks, according to some embodiments.

FIG. 3 is a flowchart of an example process for training task-specific encoders and task-specific decoders to minimize task-specific losses for a plurality of pretext tasks, according to some embodiments.

FIG. 4 is a schematic illustration of a process for generating an embedding for downstream machine learning tasks, according to some embodiments.

FIG. 5 is a flowchart of an example process for generating the embedding for downstream machine learning tasks, according to some embodiments.

In the drawings, reference numbers may be reused to identify similar and/or identical elements.

### DETAILED DESCRIPTION

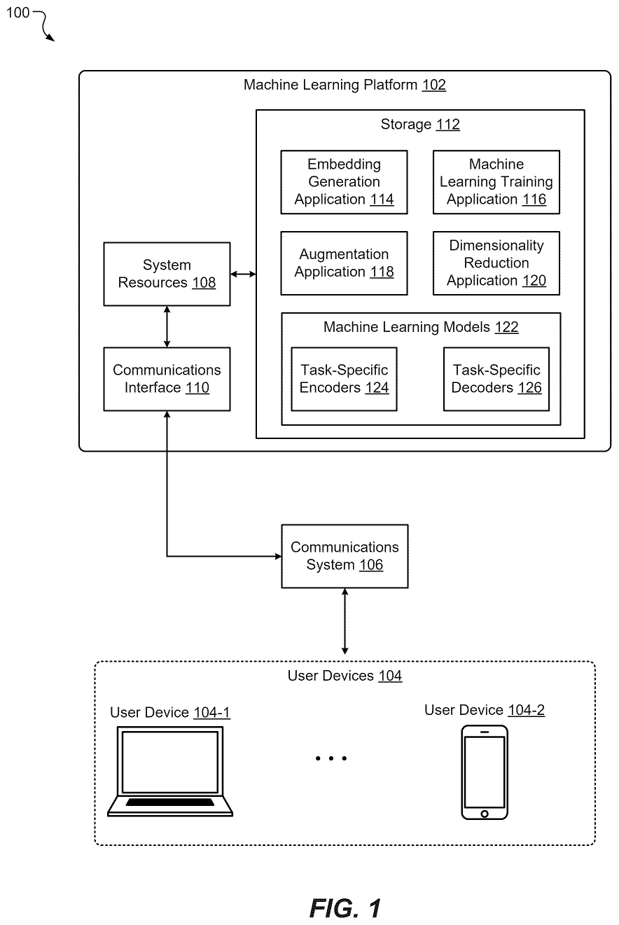

FIG. 1 is a block diagram illustrating an example computing system 100 for generating embeddings based on input data structures (such as graph representations). As illustrated in FIG. 1, some examples of the system 100 include a machine learning platform 102, one or more user devices 104 (such as, for example, user device 104-1 and user device 104-2), and/or a communications system 106. Although a single machine learning platform 102, two user devices 104, and a single communications system 106 are illustrated in FIG. 1, various implementations of the system 100 include one or more (e.g., any number) of each device, platform, and/or system. In some examples, one or more of the user devices 104 and/or the communications system 106 are omitted from the system 100. In various implementations, the media learning platform 102 communicates with the user devices 104 via the communications system 106. In some examples, the user devices 104 may include one or more computing platforms, such as smartphones, tablet computers, laptop computers, desktop computers, computer servers, etc.

In various implementations, the communications system 106 includes one or more networks, such as a General Packet Radio Service (GPRS) network, a Time-Division Multiple Access (TDMA) network, a Code-Division Multiple Access (CDMA) network, a Global System of Mobile Communications (GSM) network, an Enhanced Data Rates for GSM Evolution (EDGE) network, a High-Speed Packet Access (HSPA) network, an Evolved High-Speed Packet Access (HSPA+) network, a Long Term Evolution (LTE) network, a Worldwide Interoperability for Microwave Access (WiMAX) network, a 5th-generation mobile network (5G), an Internet Protocol (IP) network, a Wireless Application Protocol (WAP) network, or an IEEE 802.11 standards network, as well as any suitable combination of the above networks. In some examples, the communications system 106 includes an optical network, a local area network, and/or a global communication network, such as the Internet.

In various implementations, the machine learning platform 102 includes system resources 108, a communications interface 110, and non-transitory computer-readable storage media such as, for example, storage 112. The non-transitory computer-readable storage media may contain instructions that, when executed, cause one or more electronic processors (such as one or more electronic processors of the system resources 108) to perform various functions described herein. In some examples, the system resources 108 include one or more electronic processors, one or more graphics processing units, volatile computer memory, non-volatile computer memory, and/or one or more system buses interconnecting the components of the machine learning platform 102. In various implementations, the communications interface 110 includes hardware and software components that communicate with other devices, platforms, and/or systems over the communications system 106. For example, the communications interface 110 may include one or more transceivers for sending and/or receiving data over the communications system 106.

In some examples, the storage 112 includes an embedding generation application 114, a machine learning training application 116, an augmentation application 118, a dimensionality reduction application 120, and/or one or more machine learning models 122 (such as one or more task-specific encoders 124 and/or one or more task-specific decoders 126). In various implementations, the embedding generation application 114 communicates with the user devices 104 via the communications system 106, receives a data structure such as a graph representation from the user device 104, generates an embedding based on the data structure, and transmits the embedding to the user device 104 via the communications system 106. In some examples, the machine learning training application 116 trains one or more of the machine learning models 122. For example, the machine learning training application 116 trains each task-specific encoder 124 and/or each corresponding task-specific decoder 126 according to a specific pretext task.

Examples of pretext tasks may include (but are not limited to) generative reconstruction, mutual information maximization, and/or whitening decorrelation. Generative reconstruction pretext tasks may be aimed at reconstructing node features and topological information present in input graph representations. Examples of generative reconstruction tasks include feature reconstruction tasks and topology reconstruction tasks. Feature reconstruction tasks may involve masking a subset of node features present in input graph representations and reconstructing them based on their local sub-graph context. Feature reconstruction tasks may be used during training to ensure that the graph embeddings output by the encoders 124 capture the essential attributes of nodes present in the input graph representation, facilitating the recovery of masked features. Topological reconstruction tasks focus on reconstructing the links between connected nodes and may be used during training to ensure that the graph embeddings output by the encoders 124 capture topological relationships between the nodes present in the input graph representation.

Mutual information maximization pretext tasks may include tasks that maximize the mutual information between different views of the input graph representation and/or its sub-components. Mutual information maximization pretext tasks may be used during training to ensure that the graph embeddings output by the encoders 124 capture intrinsic patterns present in the graph structure of the input graph representations. Examples of mutual information maximization pretext tasks include node-graph mutual information tasks that seek to minimize the distance between the graph-level representation of an intact sub-graph and its node representations while maximizing the distance between the graph-level representation and corrupted node representations. Other examples of node-subgraph mutual maximization pretext tasks may include node-subgraph mutual information tasks that seek to maximize the similarity between representations of two views of a sub-graph associated with the same anchor nodes while minimizing the similarity between representations of sub-graphs associated with different anchor nodes.

Whitening decorrelation pretext tasks independently augment the same sub-graph of input graph representations into two views and minimize the distance between corresponding nodes in the two views while enforcing the feature-wise covariance of all nodes to be equal to the identity matrix. Whitening decorrelation pretext tasks may be used during training to prevent the encoder 124 from producing trivial or redundant representations where dimensions of the output graph embeddings are highly correlated. By enforcing decorrelation, whitening decorrelation ensures that each dimension of the output graph embedding captures unique information, resulting in more effective and meaningful representations. Other examples of suitable pretext tasks include graph coloring, graph partitioning, role prediction, node centrality prediction, graph clustering, attribute prediction, context prediction, edge attribute prediction, random walk prediction, graph reconstruction, graph denoising, temporal prediction, subtext matching, etc.

In various implementations, the augmentation application 118 receives the input data structure (such as an input graph representation) and generates an augmented data structure (such as an augmented graph representation) for each pretext task. For example, the augmentation application 118 may apply node feature masking techniques to the input graph representation to generate an augmented data structure for the feature reconstruction pretext task. Node feature masking may include masking a subset of node features (e.g., setting the values of the node to zero or a placeholder value), which encourages the encoder 124 to learn essential attributes of nodes from their local sub-graph context, facilitating the recovery of masked features during reconstruction. The augmentation application 118 may apply edge dropping techniques to the input graph representation to generate an augmented data structure for the topology reconstruction pretext task. Edge dropping may include removing a subset of edges in the graph, which encourages the encoder 124 to infer and reconstruct the missing links based on the remaining graph structure and encode topological relationships in the output graph embeddings.

The augmentation application 118 may apply first sub-graph sampling techniques to the input graph representation to generate an augmented data structure for the node-graph mutual information pretext task. The first sub-graph sampling techniques may divide the graph into smaller sub-graphs centered around randomly selected seed nodes. Different views of these sub-graphs may be created by varying the nodes and edges included in the sub-graphs. This augmentation may help the encoder 124 capture mutual information between the overall graph structure and individual node representations. The augmentation application 118 may apply second sub-graph sampling techniques to the input graph representation to generate an augmented data structure for the node-subgraph mutual information pretext task. The second sub-graph sampling techniques may divide the graph into smaller sub-graphs centered around anchor nodes. Multiple views of the same sub-graph may be created to maximize the similarity between representations of these views while minimizing the similarity between representations of sub-graphs associated with different anchor nodes. This augmentation may help the encoder 124 capture intrinsic patterns that may be present within the sub-graphs.

The augmentation application 118 may apply a double augmentation technique to the input graph representation to generate an augmented data structure for the whitening decorrelation pretext task. The double augmentation technique may augment the same sub-graph into two views (for example, using edge dropping techniques, node feature masking techniques, etc.). The double augmentation technique helps ensure that representations of the same node in both augmented views are similar while the covariance of node features across the entire graph is decorrelated to be close to the identity matrix. This may help prevent the encoder 124 from generating trivial solution and preserve orthogonal information in the latent space (e.g., in the output graph embeddings).

The dimensionality reduction application 120 may apply dimensionality reduction techniques to process and/or integrate the task-specific embeddings output by each task-specific encoder 124 into a compact representation space as a lower-dimensionality embedding. In various implementations, the dimensionality reduction application 120 concatenates the task-specific embeddings along the feature dimension. For example, if there are multiple task-specific embeddings, the multiple task-specific embeddings may be stacked together to form a single, longer concatenated embedding. The dimensionality reduction application 120 then subjects the concatenated embedding to a dimensional reduction technique to generate a final embedding, which may be a compact representation of the aggregated task-specific embeddings that preserves important features of each task-specific embedding.

Examples of suitable dimensionality reduction techniques include principal component analysis (PCA), applying an autoencoder, applying a variational autoencoder, etc. In various implementations, the dimensionality reduction application 120 applies PCA to the concatenated embedding to generate the final embedding. For example, the dimensionality reduction application 120 computes a covariance matrix of the concatenated embedding, computes eigenvalues and eigenvectors of the covariance matrix, and projects the concatenated embedding onto the eigenvectors corresponding to the largest eigenvalues (the principal components), which captures the most significant variance in the concatenated embedding.

In some examples, the dimensionality reduction application 120 trains an AE to reconstruct the concatenated embedding and extracts the latent representation of the AE as the final embedding. For example, the dimensionality reduction application 120 passes the concatenated embedding through an encoder, which compresses the concatenated embedding into a lower-dimensional representation (the latent representation). The latent representation is then provided to a decoder, which attempts to reconstruct the concatenated embedding from the latent representation. The encoder and decoder are trained to minimize the reconstruction error, which ensures that the latent representation captures essential features of the input data (the concatenated embedding). In various implementations, the dimensionality reduction application 120 trains a VAE to reconstruct the concatenated embedding and extracts the latent representation of the VAE as the final embedding. The VAE may be similar to the AE except that the loss function of the VAE includes both the reconstruction error and a regularization term (such as the Kullback-Leiber divergence) that ensure that the latent representation follows a predefined distribution. Accordingly, the encoder and decoder of the VAE may be trained to minimize both the reconstruction error and the regularization term.

The machine learning models 122 may include one or more task-specific encoders 124 and one or more task-specific decoders 126. Each task-specific encoder 124 may be associated with a particular pretext task (such as any of the above-described pretext task) and generate a task-specific embedding for the particular pretext task. Each task-specific encoder 124 may have a corresponding task-specific decoder 126 that transforms the task-specific embedding output by the task-specific encoder 124 into task-specific outputs, which are then used to calculate task-specific losses. The task-specific losses may be backpropagated through (e.g., updating the parameters of) the task-specific encoder 124 and/or the task-specific decoder 126, ensuring that each task-specific encoder 124 learns input features tailored to its specific pretext task without interference from other pretext tasks. In various implementations, the task-specific encoders 124 include graph neural network (GNN) encoders, such as two-layer graph convolutional networks (GCNs).

In some examples, the task-specific decoder 126 for the feature reconstruction pretext task may reconstruct masked node features based on the local sub-graph context. The corresponding loss function may include minimizing the reconstruction error between the task-specific output (e.g., predicted features) output from the task-specific decoder 126 and the augmented data structure (e.g., original features) input to the task-specific encoder 124 using the task-specific embedding (e.g., encoded node representations) output from the task-specific encoder 124. In various implementations, the task-specific decoder 126 for the topology reconstruction pretext task predicts the existence of edges between node pairs based on their encoded representations. The corresponding loss function may include a binary cross-entropy loss that maximizes the probability of the task-specific output (e.g., predicted node existence) output from the task-specific decoder 126 matching the augmented data structure (e.g., true edge connections) input to the task-specific encoder 124 using the task-specific embeddings (e.g., node representations) output from the task-specific encoder 124.

In some examples, the task-specific decoder 126 for the node-graph mutual information pretext task aligns node embeddings with a global representation of the sub-graph. The corresponding loss function may include minimizing the distance between the task-specific embedding (e.g., node representations) output from the task-specific encoder 124 and the task-specific output (e.g., global representation of the intact sub-graph) output from the task-specific decoder 126 while maximizing the distance from the augmented data structure (e.g., corrupted node representations) input to the task-specific encoder 124. In various implementations, the task-specific decoder 126 for the node-subgraph mutual information pretext task ensures that representations of the same sub-graph viewed from different angles are similar, while those from different sub-graphs are dissimilar. The corresponding loss function may include maximizing the similarity between the task-specific embedding (e.g., representations of the same sub-graph) output from the task-specific encoder 124 and the task-specific output (e.g., different views of the sub-graph) output from the task-specific decoder 126 while minimizing the similarity between representations of different sub-graphs using the augmented data structure input to the task-specific encoder 124.

In some examples, the task-specific decoder 126 for the whitening decorrelation pretext task decorrelates the features in node representations and promote diverse embeddings. The corresponding loss function may include minimizing the distance between the task-specific embedding (e.g., node representations) of the two views (output from the task-specific encoder 124) and ensuring the feature-wise covariance matrix of the task-specific output (output from the task-specific decoder 126) is close to an identity matrix. Additional details and functionality of the embedding generation application 114, machine learning training application 116, augmentation application 118, dimensionality reduction application 120, and the machine learning models 122 will be described herein.

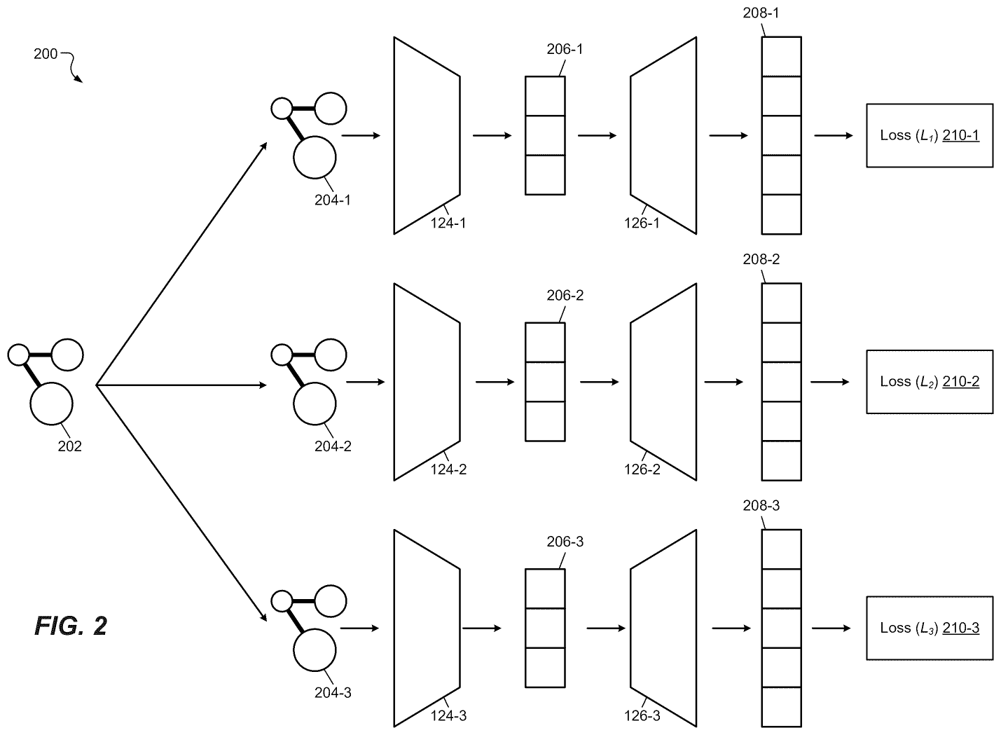

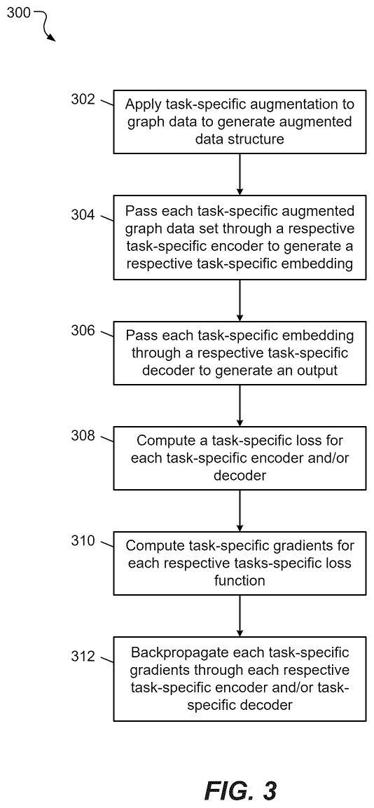

FIG. 2 is a schematic illustration 200 of a process for training task-specific encoders 124 and task-specific decoders 126 to minimize task-specific losses for a plurality of pretext tasks. FIG. 3 is a flowchart of an example process 300 for training task-specific encoders 124 and task-specific decoders 126 to minimize task-specific losses for the plurality of pretext tasks. Referring collectively to FIGS. 2 and 3, in the example process 300, the machine learning training application 116 receives an input graph representation 202 (for example, from one or more of the user devices 104) and provides the input graph representation 202 to the augmentation application 118 to generate an augmented data structure 204 (at block 302). For example, the augmentation application 118 generates an augmented data structure 204 specific to each pretext task of the plurality of pretext tasks (such as any of the previously described pretext tasks).

In the example process 300, the machine learning training application 116 provides the augmented data structure 204 generated for each pretext task to a corresponding task-specific encoder 124 to generate a corresponding task-specific embedding 206 (at block 304). For example, the machine learning training application 116 provides the augmented data structure 204-1 to the task-specific encoder 124-1 to generate the task-specific embedding 206-1, the augmented data structure 204-2 to the task-specific encoder 124-2 to generate the task-specific embedding 206-2, and the augmented data structure 204-3 to the task-specific encoder 124-3 to generate the task-specific embedding 206-3. In the example process 300, the machine learning training application 116 provides each task-specific embedding 206 through a corresponding task-specific decoder 126 to generate a task-specific output 208 (at block 306). For example, the machine learning training application 116 provides the task-specific embedding 206-1 to the task-specific decoder 126-1 to generate the task-specific output 208-1, the task-specific embedding 206-2 to the task-specific decoder 126-2 to generate the task-specific output 208-2, and the task-specific embedding 206-3 to the task-specific decoder 126-3 to generate the task-specific output 208-3.

In the example process 300, the machine learning training application 116 computes a task-specific loss 210 for the outputs of each task-specific encoder 124 and task-specific decoder 126 (at block 308). For example, the machine learning training application 116 computes a task-specific loss 210 based on the augmented data structure 204 input to the task-specific encoder 124, the task-specific embedding 206 output from the task-specific encoder 124 and provided as input to the task-specific decoder 126, and/or the task-specific output 208 output from the task-specific decoder 126 (for example, according to any of the previously described techniques).

In the example of FIG. 2, the machine learning training application 116 computes a task-specific loss 210-1 based on the augmented data structure 204-1 input to the task-specific encoder 124-1, the task-specific embedding 206-1 output from the task-specific encoder 124-1 and provided as input to the task-specific decoder 126-1, and/or the task-specific output 208-1 output from the task-specific decoder 126-1, a task-specific loss 210-2 based on the augmented data structure 204-2 input to the task-specific encoder 124-2, the task-specific embedding 206-2 output from the task-specific encoder 124-2 and provided as input to the task-specific decoder 126-2, and/or the task-specific output 208-2 output from the task-specific decoder 126-2, and a task-specific loss 210-3 based on the augmented data structure 204-3 input to the task-specific encoder 124-3, the task-specific embedding 206-3 output from the task-specific encoder 124-3 and provided as input to the task-specific decoder 126-3, and/or the task-specific output 208-3 output from the task-specific decoder 126-3.

In the example process 300, the machine learning training application 116 computes a task-specific gradient for each task-specific loss function used to generate each task-specific loss 210 (at block 310). For example, the machine learning training applications computes a task-specific gradient for the task-specific loss function used to generate the task-specific loss 210-1, a task-specific gradient for the task-specific loss function used to generate the task-specific loss 210-2, and a task-specific gradient for the task-specific loss function used to generate the task-specific loss 210-3. In the example process 300, the machine learning training application 116 backpropagates each task-specific gradient through each respective task-specific encoder 124 and/or task-specific decoder 126 (at block 312).

For example, the machine learning training application 116 backpropagates the task-specific gradient computed for the task-specific encoder 124-1 and/or the task-specific decoder 126-1 back through the task-specific encoder 124-1 and/or the task-specific decoder 126-1, the task-specific gradient computed for the task-specific encoder 124-2 and/or the task-specific decoder 126-2 back through the task-specific encoder 124-2 and/or the task-specific decoder 126-2, and the task-specific gradient computed for the task-specific encoder 124-3 and/or the task-specific decoder 126-3 back through the task-specific encoder 124-3 and/or the task-specific decoder 126-3.

In the example of FIG. 2, three augmented data structures 204-1-204-3, three task-specific encoders 124-1-124-3, three task-specific embeddings 206-1-206-3, three task-specific decoders 126-1-126-3, three task-specific outputs 208-1-208-3, and three task-specific losses 210-1-210-3 are shown corresponding to three pretext tasks. However, in various implementations, any number of task-specific encoders 124 may be trained to generate task-specific embeddings 206 according to any number of pretext tasks. Accordingly, concepts described with respect to FIGS. 2 and 3 may be scaled to include any number of augmented data structures 204, task-specific encoders 124, task-specific embeddings 206, task-specific decoders 126, task-specific outputs 208, and task-specific losses 210 corresponding to any number of pretext tasks.

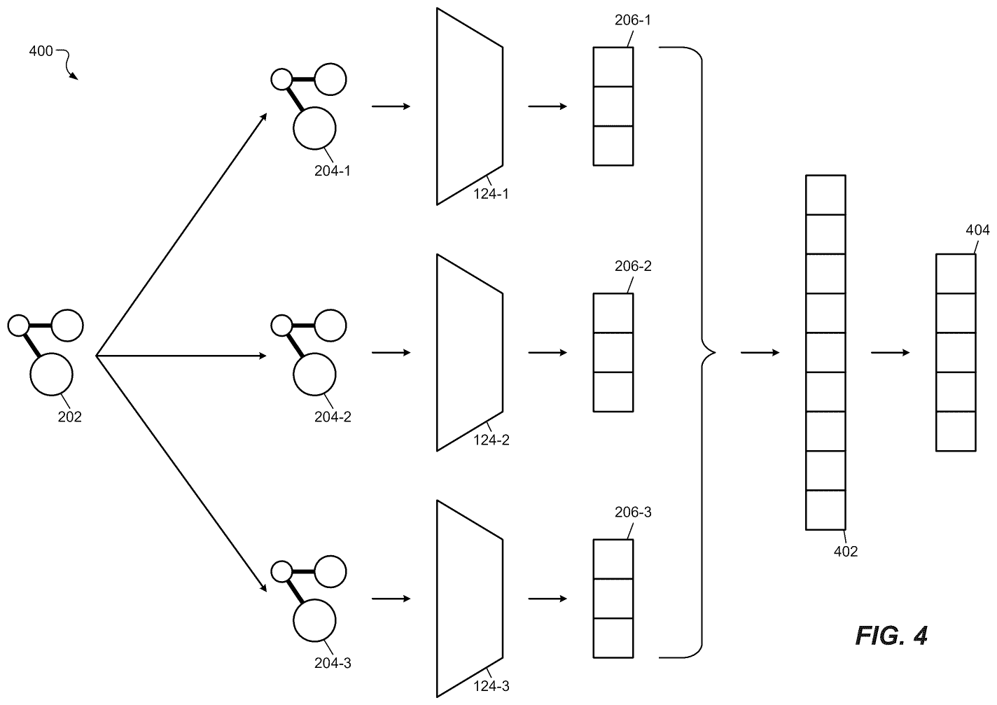

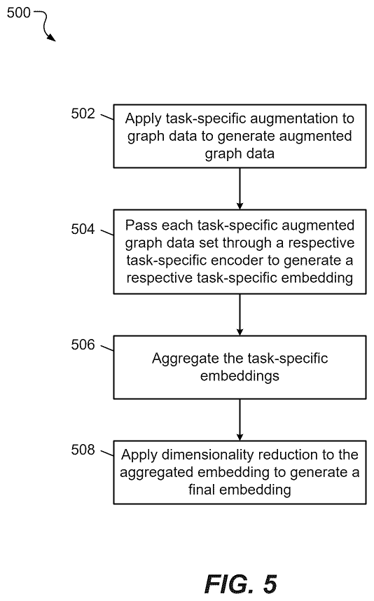

FIG. 4 is a schematic illustration 400 of a process for generating an embedding for downstream machine learning tasks. FIG. 5 is a flowchart of an example process 500 for generating the embedding for downstream machine learning tasks. Referring collectively to FIGS. 4 and 5, in the example process 500, the embedding generation application 114 receives an input graph representation 202 (for example, from one or more of the user devices 104) and provides the input graph representation 202 to the augmentation application 118 to generate an augmented data structure 204 (at block 502). For example, the augmentation application 118 generates an augmented data structure 204 specific to each pretext task of the plurality of pretext tasks (such as any of the previously described pretext tasks).

In the example process 500, the embedding generation application 114 provides the augmented data structure 204 generated for each pretext task to a corresponding task-specific encoder 124 to generate a corresponding task-specific embedding 206 (at block 504). For example, the embedding application 114 provides the augmented data structure 204-1 to the task-specific encoder 124-1 to generate the task-specific embedding 206-1, the augmented data structure 204-2 to the task-specific encoder 124-2 to generate the task-specific embedding 206-2, and the augmented data structure 204-3 to the task-specific encoder 124-3 to generate the task-specific embedding 206-3.

In the example process 500, the embedding generation application 114 aggregates each of the task-specific embeddings 206 into an aggregated embedding 402 (at block 506). For example, the embedding generation application 114 aggregates the task-specific embeddings 206-1-206-3 into the aggregated embedding 402. In various implementations, the embedding generation application 114 aggregates the task-specific embeddings 206 according to any of the previously described techniques, such as concatenating the task-specific embeddings 206 to generate a concatenated embedding as the aggregated embedding 402. In the example process 500, the embedding generation application 114 calls on the dimensionality reduction application 120 to apply dimensionality reduction to the aggregated embedding 402 to generate a final embedding 404 (at block 508). In various implementations, the dimensionality reduction application 120 applies any of the previously described dimensionality reduction techniques. The final embedding 404 may be provided for use in downstream machine learning applications. In some examples, the embedding generation application 114 provides the final embedding 404 to one or more of the user devices 104 for use in downstream machine learning applications.

In the example of FIG. 4, three augmented data structures 204-1-204-3, three task-specific encoders 124-1-124-3, and three task-specific embeddings 206-1-206-3 are shown corresponding to three pretext tasks. However, in various implementations, any number of task-specific encoders 124 may be trained to generate task-specific embeddings 206 according to any number of pretext tasks. Accordingly, concepts described with respect to FIGS. 4 and 5 may be scaled to include any number of augmented data structures 204, task-specific encoders 124, and task-specific embeddings 206 corresponding to any number of pretext tasks.

The foregoing description is merely illustrative in nature and does not limit the scope of the disclosure or its applications. The broad teachings of the disclosure may be implemented in many different ways. While the disclosure includes some particular examples, other modifications will become apparent upon a study of the drawings, the text of this specification, and the following claims. In the written description and the claims, one or more processes within any given method may be executed in a different order—or processes may be executed concurrently or in combination with each other—without altering the principles of this disclosure. Similarly, instructions stored in a non-transitory computer-readable medium may be executed in a different order—or concurrently—without altering the principles of this disclosure. Unless otherwise indicated, the numbering or other labeling of instructions or method steps is done for convenient reference and does not necessarily indicate a fixed sequencing or ordering.

It should also be noted that a plurality of hardware and software-based devices, as well as a plurality of different structural components may be utilized in various implementations. Aspects, features, and instances may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one instance, the electronic based aspects of the invention may be implemented in software (for example, stored on non-transitory computer-readable medium) executable by one or more processors. As a consequence, it should be noted that a plurality of hardware and software-based devices, as well as a plurality of different structural components may be utilized to implement the invention. For example, “control units” and “controllers” described in the specification can include one or more electronic processors, one or more memories including a non-transitory computer-readable medium, one or more input/output interfaces, and various connections (for example, a system bus) connecting the components.

Unless the context of their usage unambiguously indicates otherwise, the articles “a,” “an,” and “the” should not be interpreted to mean “only one.” Rather, these articles should be interpreted to mean “at least one” or “one or more.” Likewise, when the terms “the” or “said” are used to refer to a noun previously introduced by the indefinite article “a” or “an,” the terms “the” or “said” should similarly be interpreted to mean “at least one” or “one or more” unless the context of their usage unambiguously indicates otherwise.

It should also be understood that although certain drawings illustrate hardware and software located within particular devices, these depictions are for illustrative purposes only. In some embodiments, the illustrated components may be combined or divided into separate software, firmware, and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable connections or links.

Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations collectively. To reiterate, those electronic processors and processing may be distributed.

Spatial and functional relationships between elements—such as modules—are described using terms such as (but not limited to) “connected,” “engaged,” “interfaced,” and/or “coupled.” Unless explicitly described as being “direct,” relationships between elements may be direct or include intervening elements. The phrase “at least one of A, B, and C” should be construed to indicate a logical relationship (A OR B OR C), where OR is a non-exclusive logical OR, and should not be construed to mean “at least one of A, at least one of B, and at least one of C.” The term “set” does not necessarily exclude the empty set. For example, the term “set” may have zero elements. The term “subset” does not necessarily require a proper subset. For example, a “subset” of set A may be coextensive with set A, or include elements of set A. Furthermore, the term “subset” does not necessarily exclude the empty set.

In the figures, the directions of arrows generally demonstrate the flow of information—such as data or instructions. The direction of an arrow does not imply that information is not being transmitted in the reverse direction. For example, when information is sent from a first element to a second element, the arrow may point from the first element to the second element. However, the second element may send requests for data to the first element, and/or acknowledgements of receipt of information to the first element. Furthermore, while the figures illustrate a number of components and/or steps, any one or more of the components and/or steps may be omitted or duplicated, as suitable for the application and setting.

Additionally, operations (such as processes, decisions, inputs, outputs, actions, messages, interactions, events, and/or any other operations) shown in the flowcharts and/or message sequence charts may be illustrated once each and in a particular order in the drawings. However, in various implementations, the operations may be reordered and/or repeated as may be suitable. In some examples, different operations may be performed in parallel, as may be appropriate.

The term computer-readable medium does not encompass transitory electrical or electromagnetic signals or electromagnetic signals propagating through a medium—such as on an electromagnetic carrier wave. The term “computer-readable medium” is considered tangible and non-transitory. The functional blocks, flowchart elements, and message sequence charts described above serve as software specifications that can be translated into computer programs by the routine work of a skilled technician or programmer.

what is claimed is:

1. A computer-implemented method, comprising:
generating a plurality of task-specific embeddings at a plurality of task-specific encoders based on a plurality of input data structures;
aggregating the plurality of task-specific embeddings to generate an aggregated embedding;
applying a dimensionality-reduction technique to the aggregated embedding to the aggregated embedding to generate a final embedding; and
providing the final embedding to a user device for use in a machine learning application.

2. The method of claim 1, further comprising generating each input data structure of the plurality of input data structures by augmenting a graph representation according to a respective pretext task.

3. The method of claim 2, further comprising training each task-specific encoder of the plurality of task-specific encoders according to a respective pretext task.

4. The method of claim 3, wherein training each task-specific encoder of the plurality of task-specific encoders comprises:
providing each input data structure to a respective task-specific encoder to generate a respective task-specific embedding;
providing each task-specific embedding to a respective task-specific decoder to generate a respective task-specific output;
computing a task-specific loss for each task-specific output; and
updating each task-specific encoder according to a respective task-specific loss.

5. The method of claim 4, further comprising:
computing each task-specific loss according to a respective task-specific loss function;
computing a task-specific gradient according to each task-specific loss function; and
backpropagating each task-specific gradient through a respective task-specific encoder.

6. The method of claim 5, further comprising backpropagating each task-specific gradient through a respective task-specific decoder.

7. The method of claim 1, wherein each task-specific encoder comprises a graph neural network.

8. The method of claim 1, wherein applying the dimensionality-reduction technique comprises applying principal component analysis to reduce a dimensionality of the aggregated embedding.

9. The method of claim 1, wherein applying the dimensionality-reduction technique comprises applying an autoencoder to reduce a dimensionality of the aggregated embedding.

10. The method of claim 1, wherein applying the dimensionality-reduction technique comprises applying a variational autoencoder to reduce a dimensionality of the aggregated embedding.

11. A non-transitory computer-readable storage medium comprising executable instructions, wherein the executable instructions cause an electronic processor to:
generate a plurality of task-specific embeddings at a plurality of task-specific encoders based on a plurality of input data structures;
aggregate the plurality of task-specific embeddings to generate an aggregated embedding;
apply a dimensionality-reduction technique to the aggregated embedding to generate a final embedding; and
provide the final embedding to a user device for use in a machine learning application.

12. The non-transitory computer-readable medium of claim 11, wherein the executable instructions cause the electronic processor to generate each input data structure of the plurality of input data structures by augmenting a graph representation according to a respective pretext task.

13. The non-transitory computer-readable medium of claim 12, wherein the executable instructions cause the electronic processor to train each task-specific encoder according to a respective pretext task.

14. The non-transitory computer-readable medium of claim 13, wherein the executable instructions cause the electronic processor to train each task-specific encoder according to the respective pretext task by:
providing each input data structure to a respective task-specific encoder to generate a respective task-specific embedding;
providing each task-specific embedding to a respective task-specific decoder to generate a respective task-specific output;
computing a task-specific loss for each task-specific output; and
updating each task-specific encoder according to a respective task-specific loss.

15. The non-transitory computer-readable medium of claim 14, wherein the executable instructions cause the electronic processor to train each task-specific encoder according to the respective pretext task by:
computing each task-specific loss according to a respective task-specific loss function;
computing a task-specific gradient according to each task-specific loss function; and
backpropagating each task-specific gradient through a respective task-specific encoder.

16. The non-transitory computer-readable medium of claim 15, wherein the executable instructions cause the electronic processor to train each task-specific encoder according to the respective pretext task by backpropagating each task-specific gradient through a respective task-specific decoder.

17. The non-transitory computer-readable medium of claim 11, wherein each task-specific encoder comprises a graph neural network.

18. The non-transitory computer-readable medium of claim 11, wherein the executable instructions cause the electronic processor to apply the dimensionality-reduction technique to the aggregated embedding to generate the final embedding by applying principal component analysis to reduce a dimensionality of the aggregated embedding.

19. The non-transitory computer-readable medium of claim 11, wherein the executable instructions cause the electronic processor to apply the dimensionality-reduction technique to the aggregated embedding to generate the final embedding by applying an autoencoder to reduce a dimensionality of the aggregated embedding.

20. The non-transitory computer-readable medium of claim 11, wherein the executable instructions cause the electronic processor to apply the dimensionality-reduction technique to the aggregated embedding to generate the final embedding by applying a variational autoencoder to reduce a dimensionality of the aggregated embedding.
